(19) United States
(12) Patent Application Publication
(10) Pub. No.: US 2019/0088033 A1
(43) Pub. Date: Mar. 21, 2019

(54) SYSTEM AND METHOD OF DIGITALLY OVERLAYING CLOTHING ON AN IMAGE OF A USER

(71) Applicants: Sudhakar Kuchibotla, Croton on Hudson, NY (US); Raghuram Kuchibhatla, Croton on Hudson, NY (US)

(72) Inventors: Sudhakar Kuchibotla, Croton on Hudson, NY (US); Raghuram Kuchibhatla, Croton on Hudson, NY (US)

(21) Appl. No.: 16/136,958

(22) Filed: Sep. 20, 2018

Related U.S. Application Data
(60) Provisional application No. 62/560,941, filed on Sep. 20, 2017.

(51) Int. Cl. G06T 19/20; G06T 17/10; G06T 7/62; G06Q 30/06

(52) U.S. Cl. CPC G06T 19/20; G06T 17/10; G06T 2210/16; G06Q 30/0643; G06T 7/62

(57) ABSTRACT

The system and method of digitally overlaying an image of a clothing item on an image of a user includes a computing system having at least a processor and a memory. Computer-executable instructions are loaded on the memory and when executed by the processor, cause the processor to implement: a user interface module for uploading a first digital image of a user and for selecting a clothing item comprising a second digital image, and an overlay module for overlaying the second digital image of the clothing item on the first digital image of the user.

### CROSS-REFERENCE TO RELATED APPLICATION

This application claims the benefit of priority of U.S. provisional application No. 62/560,941, filed Sep. 20, 2017, the contents of which are herein incorporated by reference.

### BACKGROUND OF THE INVENTION

The present invention relates to a system and method of digitally overlaying clothing and more particularly to a system and method of digitally overlaying clothing on an image of a user.

Online purchases do not show how a customer appears wearing a clothing item prior to purchase. Therefore, the customer must purchase and ship the clothing item in order to physically try on the clothing. If the clothing item is not satisfactory, the customer must return the clothing item back to the company.

Currently, the only solution available in the digital world is to take a photograph of the clothing item drapes on a mannequin and publish the photograph. However, this solution does not show how the clothing item would look on a customer until a purchase is made and the product is physically tried on by the customer at home. While technology and digital/online shopping should provide enhances convenience to customers, this process of physically trying out and returning the clothing item increases the length of shopping and also frustrates customers.

As can be seen, there is a need for a system and method of digitally trying on clothing.

### SUMMARY OF THE INVENTION

In one aspect of the present invention, a method of digitally overlaying an image of a clothing item on an image of a user comprises steps of: uploading, via software running on a computer, a first digital image of a user to a database; selecting, via software running on a computer, a clothing item comprising a second digital image; and overlaying, via the software running on the computer, the second digital image of the clothing item on the first digital image of the user.

In another aspect of the present invention, a system for of digitally overlaying an image of a clothing item on an image of a user comprises: a processor; and a memory comprising computer-executable instructions that, when executed by the processor, cause the processor to implement: a user interface module for uploading a first digital image of a user and for selecting a clothing item comprising a second digital image; and an overlay module for overlaying the second digital image of the clothing item on the first digital image of the user.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention;

FIG. 2 is a flow chart of an embodiment of the present invention; and

FIG. 3 is a flow chart of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a computer software program for producing a digital image of a user trying on a clothing, such as an Indian Saree. The present invention provides customers with the convenience of trying out the product digitally before making a purchase and hence transforming the traditional brick and motor shopping experience to online.

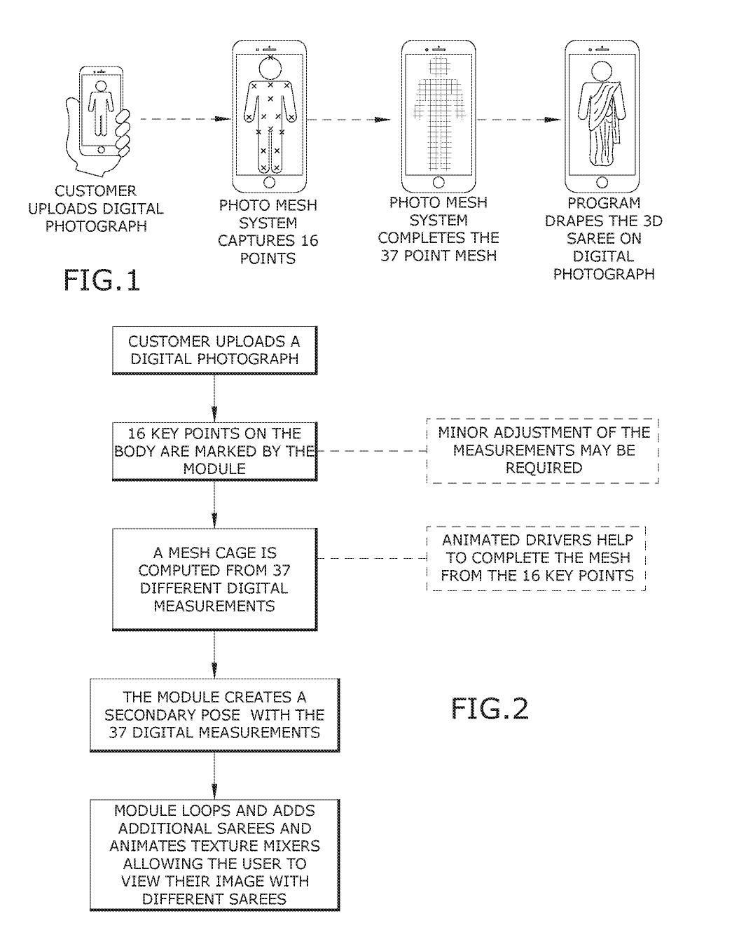

Referring to FIGS. 1 through 3, the present invention includes a system and method of overlaying a digital image of clothing on a digital image of a user. The system for digitally overlaying an image of a clothing item on an image of a user includes a computing system having at least a processor and a memory. Computer-executable instructions are loaded on the memory and when executed by the processor, cause the processor to implement: a user interface module for uploading a first digital image of a user and for selecting a clothing item comprising a second digital image, and an overlay module for overlaying the second digital image of the clothing item on the first digital image of the user.

As mentioned above, the computing system is at least the processor and the memory. The computing system may execute on any suitable operating system such as IBM's zSeries/Operating System (z/OS), MS-DOS, PC-DOS, MAC-iOS, WINDOWS, UNIX, OpenVMS, ANDROID, an operating system based on LINUX, or any other appropriate operating system, including future operating systems.

In particular embodiments, the computing system includes a processor, memory, a user interface, and a communication interface. In particular embodiments, the processor includes hardware for executing instructions, such as those making up a computer program. The memory includes main memory for storing instructions such as computer program(s) for the processor to execute, or data for processor to operate on. The memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system, where appropriate. In particular embodiments, the memory is non-volatile, solid-state memory.

The user interface module includes hardware, software, or both providing one or more interfaces for user communication with the computing system. As an example and not by way of limitation, the user interface may include a keyboard, keypad, microphone, monitor, mouse, printer, scanner, speaker, still camera, stylus, tablet, touchscreen, trackball, video camera, another user interface or a combination of two or more of these.

The communication interface includes hardware, software, or both providing one or more interfaces for communication (e.g., packet-based communication) between the computing system and one or more other computing systems or one or more networks. As an example, and not by way of limitation, communication interface may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface. As an example, and not by way of limitation, the computing system may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing system may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing system may include any suitable communication interface for any of these networks, where appropriate.

In certain embodiments, the overlay module renders the images. For example, the overlay module may covert the first digital image and the second digital image from a 2-dimensional image to a 3-dimensional image. Then the overlay module overlays a second 3-dimensional image of the second digital image on a first 3-dimensional image of the first digital image, generating an overlaid 3-dimensional image. The overlay module then converts the overlaid 3-dimensional image to an overlaid 2-dimensional image. The overlaid 2-dimensional image is then presented on a display and may be saved on a database for future use and publication.

The overlay module may create the first 3-dimensional image by using computer generated data and manually entered data. The computer generated data is acquired by mapping a plurality of key points of the user on the first digital image. The overlay module then generates a plurality of measurements of the user using the plurality of key points. The plurality of measurements includes an estimate of measurements of the users arms, chest, legs, shoulders and head. If additional data is needed, the computer system may prompt the user to manually enter measurements. The overlay module then generates a mesh cage image of the user using the plurality of measurements. The mesh cage image is the first 3-dimensional image. In certain embodiments, the mesh cage image is generated using a combination of the plurality of measurements obtained from the plurality of key points and the plurality of manually entered measurements. The plurality of key points range from about eight up to about sixteen, and the plurality of measurements range from about seventeen up to about thirty-seven. The lighting may be adjusted by accounting for different lighting used while taking the images. Animated drives help to complete mesh from sixteen key points. The module further loops through to add additional clothing items and animates the texture mixers to switch textures with each set of thirty seven dimensions.

The overlay module may further generate a simulation of the clothing prior to overlaying. The simulation of the clothing is the second 3-dimensional image. The simulation may be generated by manipulating the second image. The second image is manipulated by using group input values, such as, but not limited to, lighting, color, hue, weight, and dimensions. The dimensions are adjusted using the plurality of measurements obtained by the plurality of key points. The lighting may be adjusted by accounting for different lighting used while taking the images. The simulation generates a double glossary mix before generating a group output. Multiple gates and routines are involved in generating the material that simulates the clothing item.

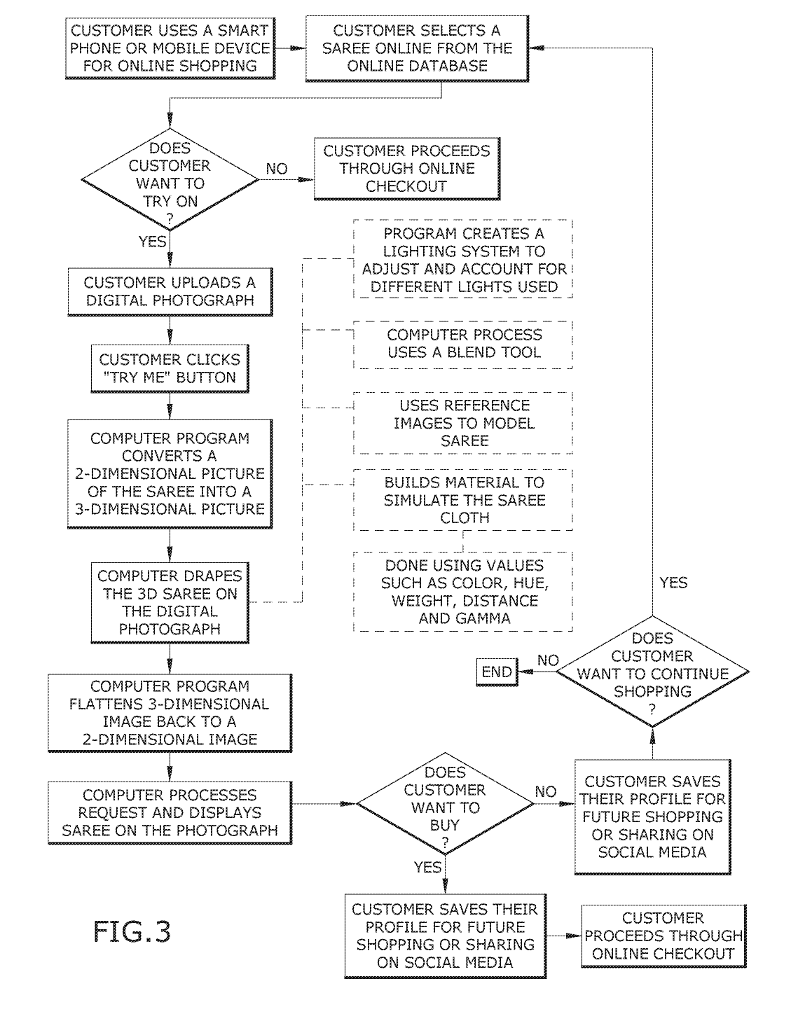

As illustrated in FIG. 3, customers (users) that are shopping online choose a clothing apparel from an online marketplace. Customers who want to try the product before purchasing, can either upload a digital photograph or choose from their saved profile if one exists, and click on a “Try Me” button. Upon conducting this step, a computer program converts the 2-dimensional picture of the photograph and the digital product into a 3-dimensional picture; drapes the clothing item about the 3-dimensional model and converts it back to a 2-dimensional picture. The computer process includes a blender tool which uses reference images to model the clothing item (saree). The present invention builds the material to simulate the saree cloth. This is done using group input values such as color, hue, weight, distance, and gamma to generate a double glossary mix before generating a group output. Multiple gates and routines are involved in generating the material that simulates the saree cloth. The program also creates a lighting system to adjust and account for the different lights that are used in taking the original saree pictures or customer's photograph. The program maps out 16 key points on the human body to generate the 37 different measurements. Animate the drivers so that the saree is rendered with all 37 different dimensions. The module creates a secondary pose by using the afore mentioned steps. Finally, the module loops through to add additional sarees and animates the texture mixers to switch textures with each set of 37 dimensions. While the initial dimensions of the model are calculated based on the uploaded picture, manual adjustments may be required to set it perfectly. Customers, after making few manual adjustment(s), may save the picture as their profile.

It should be understood, of course, that the foregoing relates to exemplary embodiments of the invention and that modifications may be made without departing from the spirit and scope of the invention as set forth in the following claims.

What is claimed is:

1. A method of digitally overlaying an image of a clothing item on an image of a user comprising steps of:
uploading, via software running on a computer, a first digital image of a user to a database;
selecting, via software running on a computer, a clothing item comprising a second digital image; and
overlaying, via the software running on the computer, the second digital image of the clothing item on the first digital image of the user.

2. The method of claim 1, further comprising steps of:
converting, via the software running on the computer, a 2-dimensional version of the first digital image and the second digital image to a first 3-dimensional image and a second 3-dimensional image respectively;
overlaying, via the software running on the computer, the second 3-dimensional digital image on the first 3-dimensional image generating an overlaid 3-dimensional image;
converting, via the software running on the computer, the overlaid 3-dimensional image to an overlaid 2-dimensional image; and
presenting, via the software running on the computer, the overlaid 2-dimensional image on a display.

3. The method of claim 2, wherein the step of converting the first image to the first 3-dimensional image comprises the steps of:
mapping, via the software running on the computer, a plurality of key points of the user on the first digital image;
generating, via the software running on the computer, a plurality of measurements of the user using the plurality of key points; and
generating, via the software running on the computer, a mesh cage image of the user using the plurality of measurements, wherein the mesh cage image is the first 3-dimensional image.

4. The method of claim 3, further comprising the step of:
uploading, via the software running on the computer, a plurality of manually entered measurements, wherein the step of generating a mesh cage image comprises using the plurality of measurements obtained from the plurality of key points and the manually entered measurements.

5. The method of claim 3, wherein the plurality of key points range from about eight up to about sixteen, and the plurality of measurements range from about seventeen up to about thirty-seven.

6. The method of claim 1, wherein the step of converting the second image to the second 3-dimensional image further comprises the step of:
adjusting, via the software running on the computer, the second images lighting, color, hue, weight, and dimensions, wherein the dimensions are adjusted using the plurality of measurements.

7. A system for of digitally overlaying an image of a clothing item on an image of a user comprising:
a processor; and
a memory comprising computer-executable instructions that, when executed by the processor, cause the processor to implement:
a user interface module for uploading a first digital image of a user and for selecting a clothing item comprising a second digital image; and
an overlay module for overlaying the second digital image of the clothing item on the first digital image of the user.

8. The system of claim 7, wherein the overlay module is further for:
converting a 2-dimensional version of the first digital image and the second digital image to a first 3-dimensional image and a second 3-dimensional image respectively;
overlaying the second 3-dimensional digital image on the first 3-dimensional image generating an overlaid 3-dimensional image;
converting the overlaid 3-dimensional image to an overlaid 2-dimensional image; and
presenting the overlaid 2-dimensional image on a display.

9. The system of claim 8, wherein the overlay module is further for:
mapping a plurality of key points of the user on the first digital image;
generating a plurality of measurements of the user using the plurality of key points; and
generating a mesh cage image of the user using the plurality of measurements, wherein the mesh cage image is the first 3-dimensional image.

10. The system of claim 9, wherein the mesh cage image is generated using a combination of the plurality of measurements obtained from the plurality of key points and a plurality of manually entered measurements.

11. The system of claim 9, wherein the plurality of key points range from about eight up to about sixteen, and the plurality of measurements range from about seventeen up to about thirty-seven.

12. The system of claim 9, wherein the overlay module is further for:
adjusting the second images lighting, color, hue, weight, and dimensions to generate the second 3-dimensional image, wherein the dimensions are adjusted using the plurality of measurements.
